(19) United States
(12) Patent Application Publication
(10) Pub. No.: US 2025/0376353 A1
(43) Pub. Date: Dec. 11, 2025

(54) Method for Communicating with an Elevator System by Means of a Mobile Terminal

(71) Applicant: Inventio AG, Hergiswil (CH)

(72) Inventor: Thomas Raber, Luzern (CH)

(21) Appl. No.: 18/878,119

(22) PCT Filed: Jun. 14, 2023
(86) PCT No.: PCT/EP2023/065920

§ 371 Date: Dec. 23, 2024

(30) Foreign Application Priority Data
Jun. 29, 2022 (EP) 22182066.5

(51) Int. Cl. B66B 1/34; G08C 23/04

(52) U.S. Cl. CPC B66B 1/3453; B66B 1/3461; G08C 23/04

(57) ABSTRACT

A method for communicating with an elevator system utilizes a mobile terminal. The method includes steps of: sending a request from the mobile terminal to the elevator system or to an elevator controller of the elevator system; generating a coded light signal by a control panel that is arranged outside an elevator shaft in response to the request; detecting the coded light signal by the mobile terminal; sending a confirmation to the elevator system that the coded light signal has been detected; and authorizing the mobile terminal to communicate with the elevator system.

### FIELD

The present invention relates to a method for communicating with an elevator system by means of a mobile terminal, and to such an elevator system and such a mobile terminal.

### BACKGROUND

An elevator system serves to transport people within buildings, wherein an elevator car is moved vertically between different floors in an elevator shaft. In order to be able to ensure the safety of passengers or service personnel, the elevator system must be serviced regularly. Many serviceable components and/or components to be serviced are present in the elevator shaft of the elevator system. In order to service such components or to carry out regular maintenance work, the elevator system is put into a servicing mode, in which automatic operation of the elevator car is blocked or the elevator car can only move at walking speed by manual control.

For servicing, it is necessary in accordance with the EN81-20 standard for a control device to be present on the roof of the elevator car and in the shaft pit in order to control the elevator car manually during servicing. For servicing, it is necessary for service personnel to step onto the roof or go down into the shaft pit. This is potentially dangerous and could easily lead to accidents. In this regard, some safety-relevant technical factors must therefore be checked before service personnel enter an elevator shaft or switch an elevator to servicing mode. In addition, certain criteria must be met for servicing, such as making certain preparations or taking various specific safety measures (check-in process). This could be challenging for service personnel, especially if they are not yet competent. Even when service personnel are sufficiently trained, they may not always know exactly what all the necessary measures are since elevators and safety requirements are very complex and may differ greatly from one to another.

Among other things, there may be a different need for a safety measure that can be used to ensure that service personnel can safely enter and in particular also safely leave an elevator shaft. An elevator system must not be put into normal operating mode while a technician is still in the shaft. Therefore, a check-out process must be carried out in order to avoid such a dangerous scenario. The safety of personnel must therefore be ensured both during and after servicing. Such requirements should be met as far as possible independently of the facilities or equipment of an elevator system.

### SUMMARY

An object of the invention is to ensure the operational safety of an elevator system not only during servicing, but also thereafter, when the elevator system is switched back to normal operating mode.

That object can be achieved by the subject matter of the advantageous embodiments defined in the following description.

According to a first aspect of the invention, a method for communicating with an elevator system by means of a mobile terminal is provided. The method can comprise the following steps:
sending a request, for example for access to the elevator system, from the mobile terminal to the elevator system;
generating a coded light signal by means of a control panel, which is arranged outside an elevator shaft of the elevator system, in response to this request;
detecting the coded light signal by means of the mobile terminal;
sending a confirmation to the elevator system that the coded light signal has been detected; and
authorizing the mobile terminal to communicate with the elevator system.
   A communication link can thus be established between the elevator system and the mobile terminal using optical transmission technology. In this transmission technology, light is modulated with a modulation signal (light signal). In principle, the light can be varied in amplitude, phase and polarization.

In order to confirm that the coded light signal has been detected, the detected coded light signal or the data of the detected coded light signal is advantageously transmitted to the elevator system. The control panel is, for example, a Lobby Operation Panel (LOP). As a result of the mobile terminal receiving a light signal generated by the elevator system and sending this light signal back to the elevator system either directly or in a modified form, such as in digital data packets, via a feedback path as feedback or confirmation, the elevator system will then recognize that a communication link exists between it and the mobile terminal via the light signal. The elevator system can therefore be reliably used in servicing mode because, on the one hand, it is possible to carry out a prescribed (complex) check-in process using the mobile terminal; on the other hand, the current position of service personnel can easily be ascertained. The elevator system can also be safely switched from servicing mode to normal operating mode without any hazardous movement of the elevator car being possible when personnel are present in the shaft or, under certain circumstances, even with a potential risk when a check-out process is to be carried out by means of the mobile terminal.

The mobile terminal can be authenticated by the elevator system if the request from the mobile terminal includes, for example, the identity thereof. In order to create a secure link, the detection of the coded light signal is pre-checked in such a way that, prior to generating the light signal, a coded test light signal is generated by means of the control panel of the mobile terminal, and the coded test light signal is detected by the mobile terminal. Like the light signal, the test light signal can also be transmitted to the elevator system directly or in a modified form (for example data or data packets). The mobile terminal can also decode the coded test light signal. By transmitting the detected test light signal, it is confirmed that the coded test light signal has been received by the mobile terminal without any problem. This means that secure communication thus exists between the mobile terminal and the elevator system.

In order to detect inadvertent changes to transmitted raw data—here the test light signal—it is possible in one advantageous embodiment according to the first aspect of the invention that the detected test light signal or the data thereof is transmitted with the addition of a check value, and/or that the detected light signal or the data thereof is likewise transmitted with the check value. The check value can be used to detect any error that may have occurred during storage or transmission of data. The check value may be designed such that errors in data transmission, such as those caused by noise on a line or a wired or wireless network, can be detected with high probability. Specifically, the check value may be designed to protect against common communication errors in order to quickly and appropriately ensure the integrity of the transmitted data or signals.

In one advantageous embodiment according to the first aspect of the invention, the coded light signal and/or the coded test light signal is generated in the form of a temporal sequence of light signals. In other words, the light signal can be coded in the time domain, for example in the manner of Morse code. In order to generate such a sequence of light signals, it is not necessary for the control panel to be equipped with a screen for displaying a light signal in graphic form. For example, instead of displaying a QR code, the relevant information can be transmitted in the form of sequences of light signals. In general, a control panel of an elevator system does not comprise a screen; if it does, then the control panel in the form of a Car Operation Panel (COP) is usually located in an elevator car. In this case, service personnel can only start their work once they are in the elevator car. On the one hand, the costs of the control panel can be reduced as a result of this advantageous design. On the other hand, the communication between the mobile terminal and the elevator system can be secured. Displaying information directly, such as a QR code for example, is not secure because the QR code is accessible to unauthorized personnel.

In one advantageous embodiment according to the first aspect of the invention, the position of the mobile terminal can be ascertained through the communication with the elevator system. The current position of service personnel can thus also be easily ascertained. Not only is it possible to ascertain whether a technician is outside an elevator shaft, but it is also possible to ascertain the floor on which the technician is currently located since the individual control panels can be individually identified.

According to a second aspect of the invention, a mobile/portable terminal for an elevator system is provided. A mobile terminal is, for example, a mobile telephone (smartphone), a laptop, a tablet computer, or a PDA (Personal Digital Assistant), etc. The mobile terminal is designed to communicate with the elevator system in such a way that
the mobile terminal sends a request to the elevator system;
the mobile terminal detects a coded light signal when the coded light signal is generated by a control panel, which is arranged outside an elevator shaft of the elevator system, in response to the request;
the mobile terminal confirms to the elevator system that the coded light signal has been detected; and
the mobile terminal is authorized by the elevator system to communicate with the elevator system.

In one advantageous embodiment according to the second aspect of the invention, the mobile terminal of the elevator system can transmit the detected coded light signal or the data thereof in order to confirm that the coded light signal has been detected. The coded light signal can be sent back to the elevator system directly or in a modified form as feedback or confirmation, so that the elevator system is informed that a communication link exists between it and the mobile terminal via the light signal.

In one advantageous embodiment according to the second aspect of the invention, the detection of the coded light signal can be pre-checked in such a way that the mobile terminal detects a coded test light signal, the test light signal being generated prior to the light signal by means of the control panel in response to this request, and the mobile terminal transmits the detected test light signal or the data thereof to the elevator system.

In one advantageous embodiment according to the second aspect of the invention, the detected test light signal or the data thereof and/or the detected light signal or the data thereof is transmitted with the addition of a check value. It is thus possible to monitor whether inadvertent errors have occurred during transmission or storage of the test light signal.

In one advantageous embodiment according to the second aspect of the invention, servicing/inspection work for the elevator system can be controlled and/or started by means of the mobile terminal. For example, service personnel can easily move an elevator car or stop it at a desired location by means of their smartphone. Service personnel can specify a desired stopping floor or a desired stopping position by means of the mobile terminal. Therefore, service personnel do not always have to be on the roof of the elevator car or in the shaft pit during servicing, but instead can be in the elevator car or outside the shaft.

According to a third aspect of the invention, an elevator system comprising a control panel is provided, the control panel being arranged outside an elevator shaft of the elevator system. The elevator system can communicate with a mobile terminal in such a way that the elevator system receives from the mobile terminal a request from the mobile terminal; a coded light signal is generated by a control panel in response to the request and is then detected by the mobile terminal; the elevator system receives a confirmation that the coded light signal has been detected; the elevator system authorizes the mobile terminal to communicate with the elevator system.

The control panel does not need to be equipped with a screen. The control panel may be, for example, a simple control panel with only one or two call buttons (up and down call buttons). It is known that light-emitting diodes (LEDs) are used as a light source in such buttons in order to illuminate a button to display an arrow symbol. The call button or the two call buttons are illuminated a certain number of times within a predetermined period of time, for example, so that the control panel can emit a temporal sequence of light signals. Furthermore, the illumination of each button can last for different lengths of time, independently of each other. In other words, the light signal can be coded in the time domain, for example in the manner of Morse code.

In one advantageous embodiment according to the third aspect of the invention, the detected coded light signal or the data thereof can be transmitted to the elevator system as confirmation that the coded light signal has been detected.

In one advantageous embodiment according to the third aspect of the invention, the detection of the coded light signal can be pre-checked in such a way that a coded test light signal is generated prior to the light signal by means of the control panel in response to this request and is then detected by the mobile terminal, and the mobile terminal transmits the detected test light signal or the data thereof to the elevator system.

In one advantageous embodiment according to the third aspect of the invention, the detected test light signal or the data thereof and/or the detected light signal or the data thereof is transmitted with the addition of a check value in order to monitor whether inadvertent errors have occurred during transmission of the test light signal.

A computer program can also be provided, which comprises instructions that cause a processor, such as a processor of the mobile terminal, to carry out the method specified above when the computer program is executed by the processor. The computer program can be stored on a computer-readable medium (USB, server, cloud, or a memory unit of the mobile terminal).

It should be noted that some of the possible features and advantages of the invention are described herein with reference to different embodiments of the inspection control system on the one hand and a method for switching an elevator system between a normal operating mode and an inspection mode on the other hand. A person skilled in the art will recognize that the features can be suitably combined, adapted, or exchanged in order to arrive at further embodiments of the invention.

One advantageous embodiment of the invention will be described below with reference to the accompanying drawings; neither the drawings nor the description are to be interpreted as limiting the invention. The drawings are only schematic and are not true to scale.

### DESCRIPTION OF THE DRAWINGS

In the drawings:

FIG. 1 is a schematic representation of an elevator system according to the invention and of a mobile terminal according to the invention,

FIG. 2 is a schematic representation of a communication between a control panel of the elevator system and the mobile terminal,

FIG. 3 is a flow chart illustrating an implementation of a method according to the invention, and

FIG. 4 is a graphical representation of the method according to the invention with a pre-check.

### DETAILED DESCRIPTION

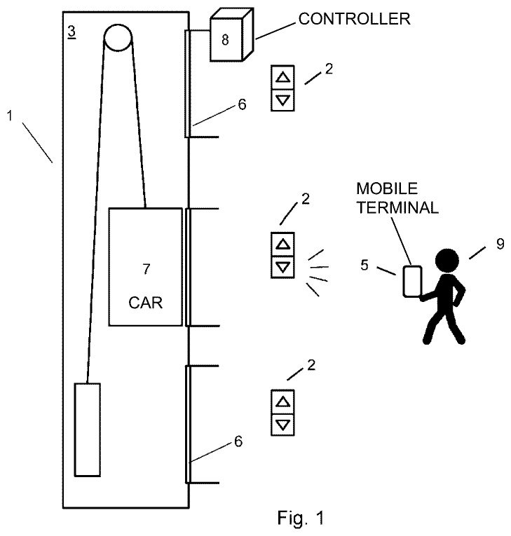

FIG. 1 illustrates details of an elevator system 1 according to the invention and of a mobile terminal 5 according to the invention. An elevator car 7 can travel between different floors in an elevator shaft 3. A shaft door 6 is provided at each floor. A control panel 2, such as an LOP, is arranged next to the shaft door 6. In the inspection or servicing mode, a technician 9 can control the elevator car 7 and move it up and down by means of a mobile terminal 5, for example a smartphone, so that he can easily stop the elevator car 7 at a desired floor or location. The mobile terminal 5 can be connected to the controller 8 of the elevator system 1 in a wireless or wired manner. The required safety measures (for example a checklist) or a check-in/check-out process can be carried out using the mobile terminal 5 prior to switching the elevator system 1 between servicing mode and normal operating mode. The technician 9 can obtain all the necessary information via the mobile terminal 5 when the mobile terminal 5 communicates with the elevator system 1. The mobile terminal 5 can also be connected to the Internet. In addition, the elevator system 1 can also be informed about the presence or current position of the technician 9. Besides ascertaining whether a technician 9 is outside or inside the elevator shaft 3, it is possible to ascertain, depending on the position of a control panel 2, the floor on which the technician is presently located, since the control panel 2 as an LOP can indicate the specific floor. A potentially dangerous scenario can therefore be avoided as far as possible. The elevator system 1 can therefore be reliably used in servicing mode or back in normal operating mode.

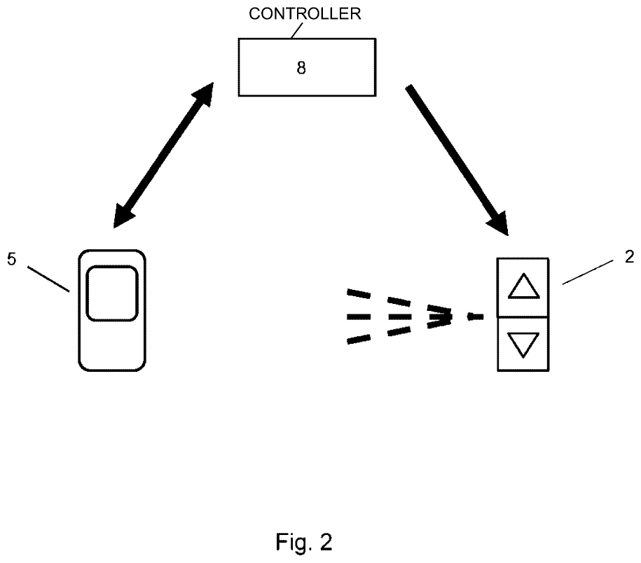

The elevator system 1 can communicate with the mobile terminal 5 by the control panel 2 generating a sequence of light signals and the mobile terminal 5 detecting this sequence of light signals. FIG. 2 shows a communication between the elevator system 1 and the mobile terminal 5. Here, the mobile terminal 5 is connected to a controller 8 of the elevator system 1 via a LAN (Local Area Network). When servicing for the elevator system 1 is to be started or finished, a corresponding check-in/check-out process must be carried out. For this, the mobile terminal 5 first sends a request via application software (for example an app) to a controller 8 of the elevator system 1, it being possible for the request to include an identity of the mobile terminal 5. The elevator system 1 can thus authenticate the mobile terminal 5. The control panel 2 then generates a coded light signal. The control panel 2 comprises, for example, two arrow buttons, each button containing an LED. The mobile terminal 5 receives the light signal and converts it into data that can be processed by the computer processor. The mobile terminal 5 then transmits the detected light signal, in the form of the converted data, to the controller 8. In order to detect any possible random errors in the detection of the light signal, a check value is added to the transmission of the light signal. By checking whether the check value has been changed, it is possible to detect a change in the transmitted light signal. If the check value is not changed, this means that the light signal has been correctly detected by the mobile terminal 5. In this case, the controller 8 can authorize the mobile terminal 5 to communicate with the elevator system 1 or to access the elevator system 1.

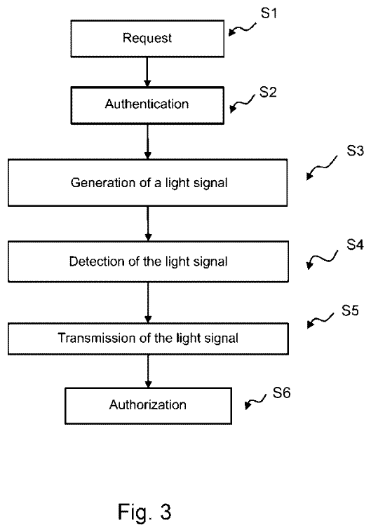

FIG. 3 shows a method according to the invention for communicating with the elevator system 1 by means of the mobile terminal 5. It will be assumed that servicing is to be carried out for an elevator system 1 shown in FIG. 1. The following steps, numbered with “S,” are therefore to be carried out:
S1: A request is sent from the mobile terminal 5 to the elevator system 1;
S2: The elevator system 1 authenticates the mobile terminal 5 if the request includes an identity of the mobile terminal 5;
S3: A coded light signal (sequence of light signals) is generated by means of the control panel 2;
S4: The coded light signal is detected by the mobile terminal 5;
S5: The mobile terminal 5 sends to the elevator system 1 the data for transmission of the detected coded light signal, so that this detection is confirmed; and
S6: The elevator system 1 authorizes the mobile terminal 5 to communicate with it.

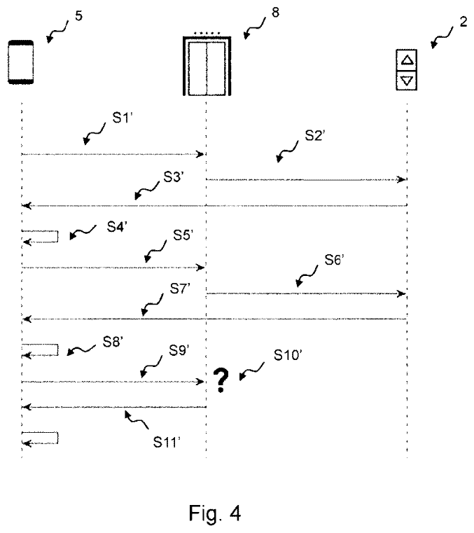

In order to ensure the detection of the light signal and communication in this way, a check value is added to the data, for example during storage or transmission. Accordingly, the method will be as shown in FIG. 4, the first two steps S1′ and S2′ being the same as the first two steps of the method in FIG. 3:
S3′: Prior to generating the official light signal, a coded test light signal is generated, it being possible for the coded test light signal likewise to be a temporal sequence of light signals;
S4′: The test light signal by the mobile terminal 5 is detected, it being possible for the mobile terminal 5 to convert the test light signal into digital data, for example;
S5′: The mobile terminal 5 sends the data with a check value added to a controller 8 of the elevator system 1, as a result of which the controller 8 is informed of this check value;
S6′: The controller 8 instructs the control panel 2 to generate a light signal again;
S7′: A coded light signal is generated by means of a control panel 2;
S8′: The coded light signal is generated by means of the mobile terminal 5. At the same time, the mobile terminal 5 likewise converts the light signal into digital data;
S9′: The mobile terminal 5 sends the data of the detected light signal to the controller 8, again with the addition of the check value;
S10′: The controller 8 checks whether the check value has been changed?
S11′: If the check value has not been changed, the controller 8 assumes that the data of the detected light signal has also not been changed. Therefore, the communication between the mobile terminal 5 and the elevator system 1 should be trustworthy. The controller 8 then authorizes the mobile terminal 5 to communicate with the elevator system 1. If the check value has changed, then it is highly likely that the detected light signal or the transmitted data does not match the generated light signal. In this case, an alarm signal is signaled. Advantageously, the entire elevator system 1 can also be shut down.

In summary, embodiments of the method presented herein allow a safety risk in an elevator shaft to be avoided at an early stage.

Finally, it should be noted that terms such as “having,” “comprising,” etc. do not preclude other elements or steps, and terms such as “a” or “one” do not preclude a plurality. Furthermore, it should be noted that features or steps which have been described with reference to one of the above exemplary embodiments may also be used in combination with other features or steps of other exemplary embodiments described above.

It should be noted that possible features and advantages of embodiments of the invention are described herein partly with reference to a method according to the invention and partly with reference to a device according to the invention. A person skilled in the art will recognize that the individual features can be suitably combined, modified, or exchanged and that features described in particular for the method can be transferred analogously to the device, and vice versa, in order to arrive at further embodiments of the invention.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A method for communicating with an elevator system using a mobile terminal, the method comprising steps of:
sending a communication request from the mobile terminal to the elevator system;
the elevator system generating a coded light signal from a control panel that is arranged outside an elevator shaft of the elevator system in response to the request;
detecting the coded light signal by the mobile terminal;
sending a confirmation from the mobile terminal to the elevator system that the coded light signal has been detected; and
authorizing the mobile terminal, by the elevator system, to communicate with the elevator system.

17. The method according to claim 16 including transmitting the detected coded light signal or a data of the detected coded light signal to the elevator system as the confirmation that the coded light signal has been detected.

18. The method according to claim 17 including transmitting the detected coded light signal with an added check value.

19. The method according to claim 17 including generating the coded light signal as a predetermined temporal sequence of light signals.

20. The method according to claim 17 including pre-checking the detection of the coded light signal by: prior to generating the coded light signal, generating a coded test light signal from the control panel; detecting the coded test light signal by the mobile terminal; and transmitting the detected coded test light signal or a data of the detected coded test light signal to the elevator system.

21. The method according to claim 20 including transmitting the detected coded test light signal and/or the detected coded light signal with an added check value.

22. The method according to claim 20 including generating the coded light signal and/or the coded test light signal as a predetermined temporal sequence of light signals.

23. The method according to claim 16 wherein the elevator system ascertains a position of the mobile terminal through communication with the mobile terminal.

24. A mobile terminal for communicating with an elevator system, the mobile terminal comprising:
the mobile terminal adapted to send a request to communicate to the elevator system;
the mobile terminal adapted to detect a coded light signal generated in response to the request by a control panel that is arranged outside an elevator shaft of the elevator system;
the mobile terminal adapted to confirm to the elevator system that the coded light signal has been detected; and
the mobile terminal adapted to communicate with the elevator system upon being authorized by the elevator system in response to the confirming by the mobile device that the coded light signal has been detected.

25. The mobile terminal according to claim 24 wherein the mobile terminal is adapted to transmit the detected coded light signal or a data of the detected coded light signal to the elevator system as the confirmation that the coded light signal has been detected.

26. The mobile terminal according to claim 25 wherein the mobile terminal is adapted to pre-check the detection of the coded light signal by detecting a coded test light signal, the coded test light signal being generated temporally prior to the coded light signal by the control panel in response to the request, and the mobile terminal transmits the detected coded test light signal or a data of the detected coded test light signal to the elevator system.

27. The mobile terminal according to claim 26 wherein the mobile terminal is adapted to add a check value to the detected coded test light signal or the data thereof and/or to the detected coded light signal or the data thereof before the transmission.

28. The mobile terminal according to claim 24 wherein the mobile terminal is adapted to control and/or start servicing or inspection work for the elevator system.

29. An elevator system including a control panel outside an elevator shaft of the elevator system, the elevator system being configured to communicate with a mobile terminal, the elevator system comprising:
the elevator system adapted to receive a request to communicate from the mobile terminal;
the elevator system adapted to respond to the request by generating a coded light signal from the control panel, the coded light signal being detectable by the mobile terminal;
the elevator system adapted to receive from the mobile terminal a confirmation that the coded light signal has been detected by the mobile terminal; and
the elevator system adapted to authorize the mobile terminal to communicate with the elevator system in response to the confirmation.

30. The elevator system according to claim 29 wherein the confirmation includes the detected coded light signal or a data of the detected coded light signal.

31. The elevator system according to claim 29 including the elevator system being adapted to pre-check the detection of the coded light signal by: generating a coded test light signal by the control panel prior to the generation of the coded light signal; the mobile terminal being adapted to detect the coded test light signal; and the mobile terminal being adapted to transmit the detected test light signal or a data of the detected test light signal to the elevator system.

32. The elevator system according to claim 31 wherein the detected test light signal or the data thereof and/or the detected light signal or the data thereof is transmitted with an added check value.
